(19) United States
(12) Patent Application Publication
(10) Pub. No.: US 2002/0007769 A1
(43) Pub. Date: Jan. 24, 2002

(54) Coating composition

(75) Inventors: Manabu Yoshioka, Kariya-shi (JP); Shigeyuki Sasaki, Nara-shi (JP); Hifumi Egusa, Hirakata-shi (JP); Atsuo Magoshi, Osaka (JP)

Correspondence Address: Connolly Bove Lodge & Hutz LLP, Suite 800, 1990 M Street, N.W., Washington, DC, 20036-3425, US

(73) Assignee: Nippon Paint Co., Ltd., Osaka (JP)

(21) Appl. No.: 09/791,849

(22) Filed: Feb. 26, 2001

(30) Foreign Application Priority Data
Feb. 25, 2000 (JP) 2000-049808

(51) Int. Cl. C09C 1/62

(52) U.S. Cl. 106/403

(57) ABSTRACT

It is an object of the present invention to provide a water-based metallic coating composition capable of providing coatings having a better appearance, superior in luster, even under high humidity conditions, as compared with the prior art water-based coating compositions.

The present invention provides a water-based metallic coating composition

which comprises a metallic pigment paste comprising a dispersion prepared in advance from a polyether polyol, a luster pigment and an organic solvent,

said polyether polyol having at least 0.02 primary hydroxyl group, on average, per molecule and a water tolerance of not less than 2.0.

### FIELD OF THE INVENTION

The present invention relates to a water-based metallic coating composition to be used in forming composite coating films on car bodies and so on.

### PRIOR ART

Generally, coatings for automobiles are rich in organic solvent content and, therefore, the organic solvents evaporate in large amounts in the step of coating or baking for curing. As one of the measures for reducing the number of steps of treating them, studies have been made to formulate coating compositions in the water-based form.

Thus, for instance, Japanese Kokai Publication Hei-07-53913 discloses a water-based coating composition which comprises a resin obtained by neutralizing at least part of a polymer derived from an amide group-containing, ethylenically unsaturated monomer, an acidic group-containing, ethylenically unsaturated monomer and a hydroxyl-containing, ethylenically unsaturated monomer, together with a carboxyl-containing acrylic resin. However, not only this but also the so-far known water-based coating compositions in general are not satisfactory in impression of luster, in particular, as compared with solvent base coating compositions.

It is an object of the present invention to provide a water-based metallic coating composition capable of providing coatings having a better appearance, superior in luster, even under high humidity conditions, as compared with the prior art water-based coating compositions.

### SUMMARY OF THE INVENTION

The present invention provides a water-based metallic coating composition

which comprises a metallic pigment paste comprising a dispersion prepared in advance from a polyether polyol, a luster pigment and an organic solvent,

said polyether polyol having at least 0.02 primary hydroxyl group, on average, per molecule and a water tolerance of not less than 2.0.

The invention also provides a water-based metallic coating composition

which comprises a resin emulsion obtained by emulsion polymerization.

The invention further provides a water-based metallic coating composition as specified above,

in which said polyether polyol has at least one primary hydroxyl group in each molecule and has a hydroxyl value of 30 to 700, and preferably has at least three primary hydroxyl groups in each molecule.

Furthermore, the invention provides a water-based metallic coating composition as specified above,

which contains a polyether resin or an alkyl resin.

### DETAILED DESCRIPTION OF THE INVENTION

The water-based metallic coating composition according to the invention comprises a metallic pigment paste comprising a dispersion prepared in advance from a polyether polyol, a luster pigment and an organic solvent, said polyether polyol having at least 0.02 primary hydroxyl group, on average, per molecule and a water tolerance of not less than 2.0. When necessary, it may further contain a resin emulsion obtained by emulsion polymerization, a curing agent, another or other coating film-forming resins, a color pigment and/or another or other additives.

The metallic pigment paste in the water-based metallic coating composition of the invention is a uniform dispersion comprising a polyether polyol, a luster pigment and an organic solvent.

The above polyether polyol has at least 0.02 primary hydroxyl group, on average, per molecule, a number average molecular weight of 300 to 3000, and has a water tolerance of not less than 2.0.

When a polyether polyol having less than 0.02 primary hydroxyl group, on average, per molecule is used, the resulting coating films will show low water resistance and low chipping resistance. The number of primary hydroxyl groups per molecule is preferably not less than 0.04. More preferably, each molecule has at least one hydroxyl group. From the viewpoint of water resistance and chipping resistance of coating films, it is preferred that the number of hydroxyl groups, inclusive not only of primary but also secondary and tertiary hydroxyl groups is at least 3 in each molecule. From the hydroxyl value viewpoint, the hydroxyl value is preferably 30 to 700. When the hydroxyl value is below the lower limit, the curability will be low and the resulting coating films will have low water resistance and low chipping resistance. Above the upper limit, the resulting coatings will be low in stability and the coating films obtained will show decreased water resistance. A hydroxyl value of 50 to 500 is particularly preferred.

When a polyether polyol having a number average molecular weight less than 300 is used, the resulting coating films will show decreased water resistance. When that molecular weight exceeds 3,000, the resulting coating films will show decreased curability and chipping resistance. A preferred range is 400 to 2,000. The molecular weight of such a polymeric material as referred to in the present specification is one determined by GPC based on the styrene polymer standards.

On the other hand, the use of a polyether polyol having a water tolerance less than 2.0 results in low water dispersibility and poor coating film appearance. A water tolerance of not less than 3.0 is especially preferred.

The term “water tolerance” is used herein to evaluate the degree of hydrophilicity and a higher value thereof means a higher level of hydrophilicity. The value of water tolerance, so referred to in the present specification, is determined by dispersing 0.5 g of the polyether polyol into 10 ml of acetone in a 100-ml beaker at 25° C., gradually adding deionized water to this mixture using a buret and determining the amount (ml) of deionized water required to cause the mixture to become turbid. This amount (ml) of deionized water is reported as the water tolerance value.

When a hydrophobic polyether polyol, for instance, is tested by this method, the polyether polyol is initially compatible well with acetone and, upon addition of a small amount of deionized water, becomes incompatible with acetone, with the result that the measurement system becomes turbid. Conversely, in the case of hydrophilic polyether polyols, a polyether polyol higher in hydrophilicity requires a larger amount of deionized water for causing turbidity. In this way, this method can determine the degree of hydrophilicity/hydrophobicity of a polyether polyol.

The content of the above polyether polyol in the water-based metallic coating composition on the resin solids basis is preferably 1 to 40% by weight, more preferably 3 to 30% by weight. Above the upper limit, the resulting coating films will show low water resistance and low chipping resistance. Below the lower limit, the appearance of the coating films will become poor.

As the above polyether polyol, there may be mentioned compounds derived from an active hydrogen-containing compound, such as a polyhydric alcohol, a polyhydric phenol and a polybasic carboxylic acid, by addition of an alkylene oxide. The active hydrogen-containing compound includes, for example, water, polyhydric alcohols (dihydric alcohols such as ethylene glycol, diethylene glycol, trimethylene glycol, propylene glycol, 1,4-butanediol, 1,6-hexanediol, neopentyl glycol, 1,4-dihydroxymethylcyclohexane and cyclohexylene glycol, trihydric alcohols such as glycerol, trihydroxyisobutane, 1,2,3-butanetriol, 1,2,3-pentanetriol, 2-methyl-1,2,3-propanetriol, 2-methyl-2,3,4-butanetriol, 2-ethyl-1,2,3-butanetriol, 2,3,4-pentanetriol, 2,3,4-hexanetriol, 4-propyl-3,4,5-heptanetriol, 2,4-dimethyl-2,3,4-pentanetriol, pentamethylglycerol, pentaglycerol, 1,2,4-butanetriol, 1,2,4-pentanetriol, trimethylolethane and trimethylolpropane, tetrahydric alcohols such as pentaerythritol, 1,2,3,4-pentanetetrol, 2,3,4,5-hexanetetrol, 1,2,4,5-pentanetetrol, 1,3,4,5-hexanetetrol, diglycerol and sorbitan, pentahydric alcohols such as adonitol, arabitol, xylitol and triglycerol, hexahydric alcohols such as dipentaerythritol, sorbitol, mannitol, iditol, inositol, dulcitol, talose and allose, octahydric alcohols such as sucrose, polyglycerol, etc.); polyhydric phenols [polyhydric phenols (pyrogallol, hydroquinone, phloroglucin, etc.), bisphenols (bisphenol A, bisphenol sulfone, etc.)]; polycarboxylic acids [aliphatic polycarboxylic acids (succinic acid, adipic acid, etc.), aromatic polycarboxylic acids (phthalic acid, terephthalic acid, trimellitic acid, etc.)], etc.; and mixtures of two or more of these. Particularly preferred as trihydric or polyhydric alcohols to be used in forming polyether polyols having at least 3 hydroxyl groups in each molecule are glycerol, trimethylolethane, trimethylolpropane, pentaerythritol, sorbitan, sorbitol and the like.

The above polyether polyols can be obtained by subjecting the above active hydrogen-containing compound and an alkylene oxide to addition reaction in the conventional manner, generally in the presence of an alkali catalyst, at ordinary pressure or under increased pressure at a temperature of 60 to 160° C. As the alkylene oxide, there may be mentioned ethylene oxide, propylene oxide, butylene oxide and like alkylene oxides, and these may be used singly or two or more of them may be used combinedly. When two or more are used, the addition may be effected in the manner of block addition or random addition.

The above polyether polyol may be a commercially available one. As examples, there may be mentioned Primepol PX-1000, Sannix SP-750 and PP-400 (all being products of Sanyo Chemical Industries) and PTMG-650 (product of Mitsubishi Chemical).

Further, for improving the pigment dispersibility therein, the above polyether polyol may be modified with a basic substance such as an amino resin, hydroxyethylethylenimine (e.g. Sogo Yakko's “HEA”) or 2-hydroxypropyl-2-aziridinylethyl carboxylate (e.g. Sogo Yakko's “HPAC”), which is further mentioned later herein, as disclosed in JP Kokai S59-138269. The amount of the modifier is preferably 1 to 10% by weight based on the polyether polyol. An amount smaller than 1% by weight cannot produce a sufficient modifying effect. An amount larger than 10% by weight may impair the stability of the modified polyether polyol.

The luster pigment, which is another component of the metallic pigment paste to be contained in the water-based metallic coating composition of the invention is not particularly restricted in form and shape. It may be colored. Preferably, however, it has a mean particle diameter (D₅₀) of 2 to 50 μm and a thickness of 0.1 to 5 μm. A scaly one having a mean diameter of 10 to 35 μm is excellent in feeling of luster, hence is more preferred.

The luster pigment includes colored or uncolored metal-made luster pigments, for example metals or alloys such as aluminum, copper, zinc, iron, nickel, tin, aluminum oxide and the like, and mixtures thereof. Further, combined use may be made of an interfering mica pigment, a white mica pigment, a graphite pigment and/or a like colored or color flat pigment.

The content of the above luster pigment in the above metallic pigment paste is preferably selected so that the pigment weight concentration (PWC) of the water-based metallic coating composition of the invention may be not more than 18.0%. Above the upper limit, a poor coating film appearance will result. More preferably, the PWC is 0.01 to 15.0%, still more preferably 0.01 to 13.0%.

The ratio, on the solid matter basis, of the luster pigment to the polyether polyol in the metallic pigment paste is preferably 1:4 to 10:1, more preferably 1:3 to 8:1. The use of an amount of the polyether polyol above the upper limit may result in decreased water resistance of coating films and chipping resistance. Below the lower limit, the dispersibility of the luster pigment will lower.

Further, the solid content, inclusive of the luster pigment and polyether polyol in the metallic pigment paste, is preferably 30 to 70% by weight, more preferably 35 to 65% by weight. Above the upper limit, the dispersibility of the luster pigment will decrease and, below the lower limit, the luster pigment will precipitate in some instances.

The organic solvent, which is another component of the metallic pigment paste to be contained in the water-based metallic coating composition of the invention, is not particularly restricted but includes, for example, toluene, xylene, n-hexane, cyclohexane, methyl acetate, ethyl acetate, isopropyl acetate, n-propyl acetate, n-butyl acetate, isobutyl acetate, methanol, ethanol, n-propyl alcohol, isopropyl alcohol, n-butyl alcohol, isobutyl alcohol, tert-butyl alcohol, 2-ethylhexanol, acetone, methyl ethyl ketone, methyl isobutyl ketone, diethylene glycol monoethyl ether, diethylene glycol monobutyl ether, 2-ethylhexyl glycol, propylene glycol monomethyl ether, propylene glycol monomethyl ether acetate, propylene glycol monoethyl ether, propylene glycol monoethyl ether acetate, ethylene glycol monomethyl ether, ethylene glycol monomethyl ether acetate, ethylene glycol monoethyl ether, ethylene glycol monoethyl ether acetate, ethylene glycol monobutyl ether, ethylene glycol monobutyl ether acetate, ethylene glycol monohexyl ether, ethylene glycol monohexyl ether acetate, and hydrocarbon solvents such as Solvesso 100 and Solvesso 150 (trademarks, product of Esso, aromatic hydrocarbon solvents). In the case that the luster pigment is a commercial product in the form of a metal powder paste, for instance, the solvent in that metal powder paste may also be contained in the metallic pigment paste.

The metallic pigment paste is preferably prepared in advance by mixing the above three components to attain uniform dispersion. The method comprising dispersing the luster pigment in the organic solvent and adding the polyether polyol gradually to the resulting uniform dispersion of the luster pigment, for instance, is more preferred since a uniform metallic pigment paste can be obtained with ease by that method.

The resin emulsion which can be contained in the water-based metallic coating composition of the invention may be generally used in water-based coatings and obtained by emulsion polymerization. The resin emulsion is preferably obtained by emulsion polymerization of an α, β-ethylenically unsaturated monomer mixture having an acid value of 3 to 50 and containing not less than 65% by weight of a (meth) acrylate ester whose ester moiety contains 1 or 2 carbon atoms.

When the amount of the (meth)acrylate ester whose ester moiety contains 1 or 2 carbon atoms as contained in the α, β-ethylenically unsaturated monomer mixture is less than 65% by weight, the coating films obtained will be poor in appearance. The (meth)acrylate ester whose ester moiety contains 1 or 2 carbon atoms includes methyl (meth)acrylate and ethyl (meth)acrylate. In the present specification, “(meth)acrylate ester” includes, within the meaning thereof, both of “acrylate ester” and “methacrylate ester”.

The α, β-ethylenically unsaturated monomer mixture has an acid value of 3 to 50, preferably 7 to 40. An acid value less than 3 cannot lead to any improvement in workability and an acid value exceeding 50 will lead to decreased water resistance of coating films. When, on the other hand, the water-based base coat coating is required to have curability, the α, β-ethylenically unsaturated monomer mixture should have a hydroxyl value of 10 to 150, preferably 20 to 100. A hydroxyl value less than 10 will fail to provide sufficient curability while a hydroxyl value exceeding 150 will lead to decreased water resistance of coating films. From the viewpoint of physical properties of coating films, it is preferred that the resin emulsion obtained by polymerization of the above α, β-ethylenically unsaturated monomer mixture have a glass transition temperature between −20° C. and 80° C.

The α, β-ethylenically unsaturated monomer mixture can have such an acid value and/or hydroxyl value as mentioned above by containing an acid group- or hydroxyl group-containing α, β-ethylenically unsaturated monomer or monomers therein.

As the acid group-containing α, β-ethylenically unsaturated monomer, there may be mentioned acrylic acid, methacrylic acid, acrylic acid dimer, crotonic acid, 2-acryloyloxyethyl phthalate, 2-acryloyloxyethyl succinate, 2-acryloyloxyethyl acid phosphate, 2-acrylamido-2-methylpropanesulfonic acid, ω-carboxypolycaprolactone mono(meth)acrylate, isocrotonic acid, α-hydroxy-ω-((1-oxo-2-propenyl)oxy)poly(oxy(1-oxo-1,6-hexanediyl)), maleic acid, fumaric acid, itaconic acid, 3-vinylsalicylic acid, 3-vinylacetylsalicylic acid and the like. Among these, acrylic acid, methacrylic acid and acrylic acid dimer are preferred.

As the hydroxyl group-containing α, β-ethylenically unsaturated monomer, there may be mentioned hydroxyethyl (meth)acrylate, hydroxypropyl (meth)acrylate, hydroxybutyl (meth)acrylate, allyl alcohol, methacryl alcohol, hydroxyethyl (meth)acrylate-ε-caprolactone adducts and the like. Preferred among these are hydroxyethyl (meth)acrylate, hydroxybutyl (meth)acrylate and hydroxyethyl (meth)acrylate-ε-caprolactone adducts.

The α, β-ethylenically unsaturated monomer mixture may contain another or other α, β-ethylenically unsaturated monomers. The other α, β-ethylenically unsaturated monomers include (meth)acrylate esters whose ester moiety contains 3 or more carbon atoms (e.g. n-butyl (meth)acrylate, isobutyl (meth)acrylate, tert-butyl (meth)acrylate, 2-ethylhexyl (meth)acrylate, lauryl (meth)acrylate, phenyl (meth)acrylate, isobornyl (meth)acrylate, cyclohexyl (meth)acrylate, tert-butylcyclohexyl (meth)acrylate, dicyclopentadienyl (meth)acrylate, dihydrodicyclopentadienyl (meth)acrylate, etc.), polymerizable amide compounds (e.g. (meth)acrylamide, N-methylol(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, N-(2-hydroxyethyl)acrylamide, N-(2-hydroxyethyl)methacrylamide, etc.), polymerizable aromatic compounds (e.g. styrene, α-methylstyrene, vinyl ketones, tert-butylstyrene, p-chlorostyrene, vinylnaphthalene, etc.), polymerizable nitriles (e.g. acrylonitrile, methacrylonitrile, etc.), α-olefins (e.g. ethylene, propylene, etc.), vinyl esters (e.g. vinyl acetate, vinyl propionate, etc.), dienes (e.g butadiene, isoprene, etc.), and so forth. One or more of these may be selected according to the intended purpose. For providing hydrophilicity with ease, the use of (meth)acrylamide is preferred.

The content of such an α, β-ethylenically unsaturated monomer(s) other than the (meth)acrylate ester whose ester moiety contains 1 or 2 carbon atoms as contained in the α, β-ethylenically unsaturated monomer mixture should be selected at an amount less than 35% by weight.

The resin emulsion to be contained in the water-based metallic coating composition of the invention is obtained by emulsion polymerization of the above α, β-ethylenically unsaturated monomer mixture. Here, the emulsion polymerization can be carried out by a method generally well known in the art. Specifically, it can be effected by dissolving an emulsifier in water or an aqueous medium containing an organic solvent such as an alcohol, as necessary, and adding dropwise the α, β-ethylenically unsaturated monomer mixture and a polymerization initiator thereinto with heating and stirring. It is also possible to add dropwise the α, β-ethylenically unsaturated monomer mixture emulsified beforehand using an emulsifier and water in the same manner.

Suited for use as the polymerization initiator are oil-soluble azo compounds (e.g. azobisisobutyronitrile, 2,2′-azobis(2-methylbutyronitrile), 2,2′-azobis(2,4-dimethylvaleronitrile), etc.), water-soluble azo compounds (e.g. anionic 4,4′-azobis(4-cyanovaleric acid) and cationic 2,2′-azobis(2-methylpropionamidine)); as well as oil-soluble redox system peroxides (e.g. benzoyl peroxide, p-chlorobenzoyl peroxide, lauroyl peroxide, tert-butyl perbenzoate, etc.) and water-soluble redox system peroxides (e.g. potassium persulfate, ammonium persulfate, etc.).

The emulsifier may be any of those commonly used in the art. Particularly preferred are, however, reactive emulsifiers such as Antox MS-60 (product of Nippon Nyukazai), Eleminol JS-2 (product of Sanyo Chemical Industries), Adeka Reasoap NE-20 (product of Asahi Denka Kogyo), Aqualon HS-10 (product of Dai-ichi Kogyo Seiyaku) and the like.

A chain transfer agent such as a mercaptan (e.g. lauryl mercaptan) and α-methylstyrene dimer may be used as necessary for controlling the molecular weight.

The reaction temperature depends on the initiator. Thus, with an azo initiator, for instance, it is 60° to 90° C. and, in a redox system, the reaction is preferably carried out at 30° to 70° C. Generally, the reaction time is 1 to 8 hours. The initiator amount relative to the total amount of the α, β-ethylenically unsaturated monomer mixture is generally 0.1 to 5% by weight, preferably 0.2 to 2% by weight.

The above emulsion polymerization may be carried out in two stages. Thus, part of the α, β-ethylenically unsaturated monomer mixture (α, β-ethylenically unsaturated monomer mixture 1) is first subjected to emulsion polymerization and then the remaining α, β-ethylenically unsaturated monomer mixture (α, β-ethylenically unsaturated monomer mixture 2) is further added to conduct the emulsion polymerization.

For forming composite coating films having a high quality appearance, the α, β-ethylenically unsaturated monomer mixture 1 preferably contains an amide group-containing, α, β-ethylenically unsaturated monomer. In that case, it is more preferable for the α, β-ethylenically unsaturated monomer mixture 2 to be free of any amide group-containing, α, β-ethylenically unsaturated monomer. Since the α, β-ethylenically unsaturated monomer mixtures 1 and 2 combinedly constitute the above-mentioned α, β-ethylenically unsaturated monomer mixture, the above-mentioned requirements imposed on the α, β-ethylenically unsaturated monomer mixture are satisfied by combination of the α, β-ethylenically unsaturated monomer mixtures 1 and 2.

The thus-obtained resin emulsion preferably has a particle diameter within the range of 0.01 to 1.0 μm. When the particle diameter is smaller than 0.01 μm, the workability improving effect will be little. A particle diameter larger than 1.0 μm may possibly impair the appearance of the resulting coating films. The particle size can be controlled by adjusting the monomer composition and/or emulsion polymerization conditions.

The above resin emulsion may be used at pH 5 to 10 by neutralizing with a base, as necessary. This is because the stability of the resin is high in this pH range. The neutralization is preferably carried out before or after emulsion polymerization by adding a tertiary amine such as dimethylethanolamine and triethylamine.

The water-based metallic coating composition of the invention may contain a curing agent. The curing agent may be any of those used in coatings in general. As such, there may be mentioned amino resins, blocked isocyanates, epoxy compounds, aziridine compounds, carbodiimide compounds, oxazoline compounds, metal ions, and the like. From the viewpoint of coating film characteristics and production cost, amino resins and/or blocked isocyanates are generally used.

The amino resin as a curing agent is not particularly restricted but may be a water-soluble melamine resin or a water-insoluble melamine resin. From the viewpoint of the stability of the water-based metallic coating composition, a melamine resin having a water tolerance of not less than 3.0 is preferably used among other melamine resins. The water tolerance can be determined by the same method as mentioned hereinabove referring to the polyether polyol.

As the blocked isocyanate, there may be mentioned those products obtained by adding an active hydrogen-containing blocking agent to a polyisocyanate such as trimethylene diisocyanate, hexamethylene diisocyanate, xylylene diisocyanate and isophorone diisocyanate and capable of regenerating isocyanato groups upon dissociation of the blocking agent when heated and reacting with a functional group(s) in the resin component(s) mentioned above.

When such a curing agent is contained, the content thereof is preferably 20 to 100 parts by weight per 100 parts by weight of the resin solids in the water-based metallic coating composition. Outside the above range, insufficient curability will result.

The water-based metallic coating composition of the invention may contain another or other coating film-forming resins as necessary. Such resins are not particularly restricted but use may be made of acrylic resins, polyester resins, alkyd resins, epoxy resins, urethane resins and like coating film-forming resins.

The other coating film-forming resins have a number average molecular weight of 3,000 to 50,000, preferably 6,000 to 30,000. With a lower molecular weight than 3,000, the workability in application and the curability will be insufficient and, with a molecular weight exceeding 50,000, the nonvolatile matter content becomes excessively low in the coating step and the workability in application becomes rather poor.

The other coating film-forming resins preferably have an acid value of 10 to 100 mg KOH/g, more preferably 20 to 80 mg KOH/g. Above the upper limit, the water resistance of coating films will decrease. Below the lower limit, the resin dispersibility in water will decrease. Further, the resins preferably have a hydroxyl value of 20 to 180 mg KOH/g, more preferably 30 to 160 mg KOH/g. Above the upper limit, the water resistance of coating films will decrease while, below the lower limit, the coating film curability will decrease.

As the above film-forming resins, polyester resins or alkyd resins are preferred in view of the flip-flop properties or chipping resistance of the obtained coating film.

The above polyester resin can be obtained by condensation polymerization between acid components and alcohol components. The acid components are not restricted but include polyhydric carboxylic acids and their derivatives such as adipic acid, sebacic acid, isophthalic acid, phthalic anhydride, etc. Moreover, acid components also include compounds having a carboxylic acid group and a hydroxy group per molecule, e.g. dimethylolpropionic acid. Furthermore, the above alcohol components are not particularly restricted but include polyhydric alcohol compounds such as ethylene glycol, trimethylolpropane, neopentyl glycol and the like.

The above alkyd resins are not particularly restricted, and can be obtained by condensation polymerization of the above acid components, the above alcohol components and an oil such as coconut oil, linseed oil and the like.

Furthermore, the above film-forming resin may be neutralized with basic compounds such as tertiary amine such as dimethylethanolamine and triethylamine to thereby dissolve or disperse the resin in water.

Of the resin components in the water-based metallic base coating composition, the proportions of the resin emulsion and other coating film-forming resins are such that the resin emulsion accounts for 5 to 95% by weight, preferably 10 to 85% by weight, more preferably 20 to 70% by weight, and the other coating film-forming resins account for 95 to 5% by weight, preferably 90 to 15% by weight, more preferably 80 to 30% by weight, based on the total resin solids. When the resin emulsion accounts for less than 5% by weight, sagging prevention may become insufficient and the appearance of the coating film may become poor and, at a content higher than 95% by weight, the resulting coating films will become poor in appearance.

As the color pigment to be contained in the water-based metallic coating as necessary, there may be mentioned, for example, organic pigments such as azo chelate pigments, water-insoluble azo pigments, condensed azo pigments, phthalocyanine pigments, indigo pigments, perinone pigments, perylene pigments, dioxane pigments, quinacridone pigments, isoindolinone pigments and metal complex pigments as well as inorganic pigments such as chrome yellow, yellow iron oxide, iron oxide red, carbon black and titanium dioxide. Useful as extender pigments are calcium carbonate, barium sulfate, clay, talc and so forth.

In the case that such a color pigment is contained, the amounts of the pigments, inclusive of the luster pigment and other all pigments, in the coating composition are preferably adjusted so that the total pigment weight concentration (PWC) may account for 0.1 to 50%, more preferably 0.5% to 40%, still more preferably 1.0 to 30%. Above the upper limit, the appearance of the coating film will become poor.

Further, in the case that the water-based metallic coating to be used in the practice of the invention contains a scaly luster pigment, the coating preferably contains a phosphoric acid group-containing acrylic resin. This phosphoric acid group-containing acrylic resin is obtained by copolymerizing a monomer represented by the general formula (I) given below and another ethylenic monomer.

CH₂=CXCO(OY)ₙOPO(OH)₂ (I)

(In the formula, X represents a hydrogen atom or a methyl group, Y represents an alkylene group containing 2 to 4 carbon atoms and n represents an integer of 3 to 30.)

The phosphoric acid group-containing acrylic resin is used for improving the dispersibility of the above luster pigment. This resin preferably has an acid value of 15 to 200 mg KOH/g, a phosphoric acid group-due acid value of 10 to 150 mg KOH/g, and a number average molecular weight of 1,000 to 50,000. When the acid value is less than 15 mg KOH/g, the dispersion of the scaly luster pigment may not be sufficient in certain cases. When the acid value is in excess of 200 mg KOH/g, the water-based metallic coating may have poor storage stability in some instances. The phosphoric acid group-due acid value is more preferably 15 to 100 mg KOH/g out of the acid value of 15 to 200 mg KOH/g.

When, on the other hand, the number average molecular weight is below 1,000, the dispersing effect of the invention may not be fully produced in some instances. When it exceeds 50,000, the appearance of the coating film may become poor as the case may be. The phosphoric acid group-containing acrylic resin may have a hydroxyl value contributive to curing and the value is preferably 20 to 200 mg KOH/g.

The phosphoric acid group-containing acrylic resin is used preferably in an amount of 0.01 to 5 parts by weight, more preferably 0.1 to 4 parts by weight, most preferably 0.2 to 3 parts by weight, per 100 parts by weight of the resin solids in the coating. When the phosphoric acid group-containing acrylic resin is used in an excessively small amount, the water resistance may decrease in certain cases. When the content of the phosphoric acid group-containing acrylic resin is excess, the resulting coating shows decreased storage stability.

As specific examples of the monomer represented by the above general formula (I), there may be mentioned acid phosphoxyhexa(oxypropylene) monomethacrylate and acid phosphoxydodeca (oxypropylene) monomethacrylate, and the like.

The other ethylenic monomer is copolymerizable with the monomer of the general formula (I) and may be a monomer mixture comprising a plurality of species. It also serves to render the copolymer obtained, namely acrylic resin, curable by means of a curing agent. As specific examples, there maybe mentioned monomers having an acid group (e.g. carboxyl group, sulfonic group) or a hydroxyl group.

Further, the water-based metallic coating to be used in the practice of the invention may contain a phosphate ester having a long-chain alkyl group containing 8 to 18 carbon atoms and having an HLB value of 3 to 12 for purposes of the latter serving as a corrosion inhibitor for the metal-made luster pigment, when such is used, or improving the wettability of the luster pigment and improving the physical properties of the coating film.

The alkyl chain mentioned above preferably contains 8 to 18 carbon atoms. When the number of carbon atoms is less than 8, decreased wettability may result, leading to decreased adhesion. When the number of carbon atoms exceeds 18, the compound may precipitate out in the coating, thus causing troubles. More preferably, the number of carbon atoms is 10 to 14; then, the wettability and adhesion are improved. The above compound has an HLB value of 3 to 12, preferably 4 to 8. This value is calculated from Griffin's weight fraction-based formula: HLB=20×(MH/M) [where MH means the molecular weight of the hydrophilic moiety and M means the molecular weight of the active agent]. The molecular weight of the phosphoric acid ester, sulfonic acid or carboxylic acid is used as the molecular weight of the hydrophilic moiety. Outside the above range, decreases in wettability will unfavorably be encountered.

As preferred compounds, there may be mentioned 2-ethylhexyl acid phosphate, mono- or di-isodecyl acid phosphate, mono- or di-tridecyl acid phosphate, mono- or di-lauryl acid phosphate, mono- or di-nonylphenyl acid phosphate and the like.

The above component is used preferably in an amount (as solid content) of 0.1 to 5% by weight, more preferably 0.2 to 2% by weight, based on the total resin solids. Below the lower limit, the adhesion will decrease and, above the upper limit, the water resistance will become low on the contrary.

The water-based metallic coating composition may contain another viscosity modifier to prevent imbibing with the top coat coating film and/or secure the workability in application. The viscosity modifier may be any of those generally showing thixotropic properties. As the viscosity modifier, there may be mentioned, for example, crosslinked or noncrosslinked resin particles, swollen dispersions of fatty acid amide, amide type fatty acids, polyamides such as long-chain polyaminoamide phosphates, polyethylene type ones such as colloidal swollen dispersions of oxidized polyethylene, organic acid smectite clays, montmorillonite and like organic bentonite type ones, inorganic pigments such as aluminum silicate and barium sulfate, and flat pigments capable of producing viscosity owing to the shape thereof.

The water-based metallic coating composition of the invention may contain, in addition to the above components, one or more of those additives generally used in coating compositions, such as surface modifiers, thickening agents, antioxidants, ultraviolet absorbers, antifoams, etc. The addition amount of these are within the ranges respectively well known in the art.

The method of preparing the coating composition in the practice of the invention is not particularly restricted but may be any of all the methods known in the art, inclusive of those to be mentioned later herein, for example the method comprising dispersing by kneading the pigment and other compositions using a kneader or roll mill.

The water-based metallic coating composition of the invention is generally used in forming a composite coating film by applying the composition to a substrate to be coated and applying a clear coating to the thus-obtained metallic base coating.

As the substrate, there may be mentioned various substrates, such as metals, plastics and foamed bodies. The coating composition can advantageously be applied to metal surfaces and castings, in particular, and can most judiciously be applied to metal products coatable by cationic electrodeposition coating.

As the metal products, there may be mentioned products made of iron, copper, aluminum, tin, zinc and the like as well as alloys containing these metals. Specifically, mention may be made of bodies and parts of cars, trucks, motorcycles, buses and the like. Most preferably, these metals are subjected in advance to chemical conversion treatment with a phosphate or chromate salt or the like.

An electrodeposition coating film may be formed on such chemically converted steel panel surface and, in that case, the electrodeposition coating composition may be a cationic or anionic type one. A cationic electrodeposition coating composition is preferred, however, since it gives multilayer coating films better in corrosion resistance.

As the plastics products, there may be mentioned products made of polypropylene resins, polycarbonate resins, urethane resins, polyester resins, polystyrene resins, ABS resins, vinyl chloride resins, polyamide resins and the like. Specifically, there may be mentioned spoilers, bumpers, mirror covers, grilles, door knobs and other automotive parts, and the like. These plastics products are preferably washed by vapor cleaning using trichloroethane or washed with a neutral detergent. Further, they may be coated with a primer for enabling electrostatic coating.

When necessary, an intermediate coat coating film may be formed on the above substrates. For forming the intermediate coat coating film, an intermediate coat coating is used. This intermediate coat coating contains a coating film-forming resin, a curing agent, one or more of various organic or inorganic color pigments and extender pigments, and so forth.

The above-mentioned coating film-forming resin is not particularly restricted. It is used in combination with the curing agent. From the viewpoints of coating film characteristics and cost, an amino resin and/or an isocyanate is generally used as the curing agent.

Usable as the color pigment to be contained in the intermediate coat coating are those mentioned hereinabove referring to the water-based metallic coating composition in the same manner. Normally, a gray intermediate coat coating in which carbon black and titanium dioxide are used as main pigments, a set gray one matched in hue to the topcoat, or the so-called color intermediate coat coating in which various color pigments are used combinedly is preferred. Further, a flat pigment such as an aluminum or mica powder may be added.

In these intermediate coat coatings, there may be incorporated, in addition to the components mentioned above, one or more of those additives generally used in coatings, such as surface modifiers, antioxidants, antifoams, etc.

On the other hand, the clear coating is not particularly restricted but may be any of clear coatings containing a coating film-forming resin and a curing agent and other components. It may contain a color pigment in an amount which will not impair the design of the undercoat. This clear coating may have a solvent-based or water-based form or a powder form.

As preferred examples of the solvent-based clear coating, there may be mentioned, from the viewpoint of transparency or acid etching resistance, for example, combinations of an acrylic resin and/or polyester resin and an amino resin and/or isocyanate, or acrylic resins and/or polyester resins having a carboxylic acid-epoxy curing system.

As examples of the water-based clear coating, there may be mentioned those containing a coating film-forming resin included among those mentioned hereinabove to be contained in the solvent-based clear coatings as rendered water-based one by neutralization with a base. This neutralization can be carried out before or after polymerization by adding a tertiary amine such as dimethylethanolamine and triethylamine.

As for the powder-form clear coatings, ordinary powder coatings such as thermoplastic or thermosetting powder coatings can be used. Thermosetting powder coatings are preferred, however, since they give coating films having good physical properties. Specific examples of the thermosetting powder coating are epoxy, acrylic and polyester type powder clear coatings, among which acrylic powder clear coatings capable of providing good weathering resistance are particularly preferred.

Further, to the above clear coating, a viscosity modifier is preferably added to thereby secure the workability in application. The viscosity modifier may be any of those generally showing thixotropic properties. Usable as such are those already mentioned hereinabove. The coating may contain a curing agent, a surface modifier and/or the like, when necessary.

In forming multilayer coating films using the water-based metallic coating composition of the invention, a metallic coating film and a clear coating film are formed, using the water-based metallic coating and the clear coating, respectively, in that order on a substrate, with an electrodeposited coating and an intermediate coating formed thereon as necessary.

In applying the water-based metallic coating composition of the invention to car bodies, coatings can be formed by multistage coating, preferably two-stage coating, using the electrostatic air spray coating technique or by the coating method combinedly using the electrostatic air spray coating technique and a rotary atomizer type electrostatic coater commonly known as “μ μ (micromicro) bell”, “μ (micro) bell” or “metallic bell”, for instance.

The coating film thickness to be attained in applying the water-based metallic coating composition in the practice of the invention may vary according to the intended use but a thickness of 10 to 30 μm is useful in many instances. Above the upper limit, the image sharpness may decrease or troubles such as unevenness or runs may occur in the step of application. Below the lower limit, the substrate cannot be masked.

While it is also possible to apply a clear coating to this metallic coating film after baking thereof, it is preferable from the economy and environmental viewpoint to apply the clear coating onto the uncured metallic coating film to thereby form a clear coating film, since, by doing so, the process for baking can be omitted. For obtaining good finish coating films, it is desirable that the uncured metallic coating film is heated in advance at 40° to 100° C. for 2 to 10 minutes before application of a clear coating.

In this multilayer coat formation, the clear coating film applied after formation of the metallic coating film is formed for the purpose of smoothing the unevenness, twinklings and like effects caused by the base coat coating film and protecting the same. As for the specific method of application, it is preferable to form coatings by using a rotary atomizer type electrostatic coater such as the μ μ bell or μ bell mentioned above.

As for the dry film thickness of the clear coatings formed by the clear coating, a thickness of about 10 to 80 μm is generally preferred and a thickness of about 20 to 60 μm is more preferred. If the upper limit is exceeded, such troubles as foaming and sagging are liable to take place. Below the lower limit, the unevenness of the substrate cannot be masked.

The formation of the clear coating film to be obtained in the above manner is preferably carried out by the so-called two-coat one-bake method, as mentioned above, namely followed by baking the same together with the uncured metallic base coating film.

The baking temperature is selected within the range of 80° to 180° C., preferably 120° to 160° C., whereby cured coating films with a high crosslinking density can be obtained. Above the upper limit, the coating films may become hard and brittle and, below the lower limit, a sufficient level of hardness cannot be obtained. The curing time may vary depending on the curing temperature but, at 120° C. to 160° C., 10 to 30 minutes is adequate.

The thus-obtained multilayer coatings have, in many instances, a thickness of 30 to 300 μm, preferably 50 to 250 μm. Above the upper limit, the physical properties, such as thermal shock resistance, of the coatings decrease and, below the lower limit, the strength of the coatings themselves lowers.

The invention has made it possible to stably provide water-based metallic coating compositions capable of forming composite coating films having a high L value and good luster. Further, the water-based metallic coating compositions of the invention can form composite coating films having a high L value and good luster industrially and stably even under high humidity conditions. Furthermore, when the coating contains a polyester resin or an alkyd resin, the coating film as obtained has more excellent flip-flop properties and chipping resistance.

### EXAMPLES

The following specific examples illustrate the present invention in detail. They are, however, by no means limitative of the scope of the invention. In the following, “part(s)” means “part(s) by weight”.

### Production Example

Production of resin emulsion A-1

A reaction vessel was charged with 126.5 parts of deionized water, and the temperature was raised to 80° C. with stirring in a nitrogen atmosphere. Then, a monomer emulsion (as the fist-stage α, β-ethylenically unsaturated monomer mixture) composed of 30.61 parts of methyl acrylate, 37.97 parts of ethyl acrylate, 7.42 parts of 2-hydroxyethyl methacrylate, 4.00 parts of acrylamide, 0.5 part of Aqualon HS-10 (polyoxyethylene alkylpropenyiphenyl ether sulfate ester, product of Daiichi Kogyo Seiyaku), 0.5 part of Adeka Reasoap NE-20 (α-[1-[(allyloxy)methyl]-2-(nonylphenoxy)ethyl]-ω-hydroxyoxyethylene, product of Asahi Denka Kogyo, 80% aqueous solution) and 80 parts of deionized water and an initiator solution composed of 0.24 part of ammonium persulfate and 10 parts of deionized water were added dropwise simultaneously to the reaction vessel over 2 hours. After completion of the dropping, maturation was effected at the same temperature for 1 hour.

Further, at 80° C., a monomer emulsion (as the second-stage α, β-ethylenically unsaturated monomer mixture) composed of 15.07 parts of ethyl acrylate, 1.86 parts of 2-hydroxyethyl methacrylate, 3.07 parts of methacrylic acid, 0.2 part of Aqualon HS-10 and 10 parts of deionized water and an initiator solution composed of 0.06 part of ammonium persulfate and 10 parts of deionized water were added dropwise in parallel to the reaction vessel over 0.5 hour. After completion of the dropping, maturation was effected at the same temperature for 2 hours.

Then, after cooling to 40° C., the reaction mixture was filtered through a 400-mesh filter, and then adjusted to pH 6.5 by adding 167.1 parts of deionized water and 0.32 part of dimethylaminoethanol to give an acrylic resin emulsion (A-1) with a mean particle size of 150 nm, a nonvolatile matter content of 20%, a solid matter acid value of 20 and a hydroxyl value of 40.

Production of acrylic resin B-1

A reaction vessel was charged with 23.89 parts of dipropylene glycol methyl ether and 16.11 parts of propylene glycol methyl ether, and the contents were heated to 105° C. with sitting in a nitrogen atmosphere. Then, 13.1 parts of methyl methacrylate, 68.4 parts of ethyl acrylate, 11.6 parts of 2-hydroxyethylmethacrylate, 6.9 parts of methacryclic acid and an initiator solution composed of 10.0 parts of dipropylene glycol methyl ether and 1 part of tert-butylperoxy 2-ethylhexanoate were added dropwise in parallel to the reactor over 3 hours. After completion of the dropping, maturation was effected at the same temperature for 0.5 hour.

Further, an initiator solution composed of 5.0 parts of dipropylene glycol methyl ether and 0.3 part of tert-butylperoxy-2-ethylhexanoate was added dropwise to the reactor over 0.5 hour. After dropping, maturation was effected at the same temperature for 2 hours.

A portion (16.11 parts) of the solvent was distilled off at 110° C. under reduced pressure (70 torr) using a solvent removing apparatus, and 204 parts of deionized water and 7.14 parts of dimethylaminoethanol were then added to give a solution of an acrylic resin (B-1). The thus-obtained solution of acrylic resin B-1 had a nonvolatile matter content of 30.0%, a solid matter acid value of 40, a hydroxyl value of 50 and a viscosity of 140 poises (E type viscometer, 1 rpm/25° C.).

Synthesis of a phosphoric acid group-containing acrylic resin

A one-liter reaction vessel equipped with a stirrer, a temperature adjusting device and a condenser was charged with 40 parts of ethoxypropanol. Thereto was added dropwise 121.7 parts of a monomer solution composed of 4 parts of styrene, 35.96 parts of n-butyl acrylate, 18.45 parts of ethylhexyl methacrylate, 13.92 parts of 2-hydroxyethyl methacrylate, 7.67 parts of methacrylic acid, a solution (40 parts) of 20 parts of Phosmer PP (acid phosphoxyhexa(oxypropylene) monomethacrylate, product of Unichemical) in 20 parts of ethoxypropanol and 1.7 parts of azobisisobutyronitrile at 120° C. over 3 hours, followed by further 1 hour of stirring.

The resin obtained had an acid value of 105 mg KOH/g, of which the acid value attributable to the phosphoric acid group was 55 mg KOH/g, a hydroxyl value of 60 mg KOH/g and a number average molecular weight of 6,000. The product occurred as an acrylic varnish with a nonvolatile matter content of 63%.

Polyether polyol C-1

Primepol PX-1000 (bifunctional polyether polyol, number average molecular weight 400, hydroxyl value 278, primary/secondary hydroxyl value ratio=63/37, water tolerance infinite, product of Sanyo Chemical Industries) was used.

Polyether polyol C-2

Sannix SP-750 (hexafunctional polyether polyol, number average molecular weight: 750, hydroxyl value: 494, primary/secondary hydroxyl value ratio=2/98, water tolerance: infinite, product of Sanyo Chemical Industries) was used.

Polyether polyol C-3

A reaction vessel equipped with a stirrer was charged with 90 parts of PP-400 (bifunctional polyether polyol, number average molecular weight: 400, hydroxyl value: 280, primary/secondary hydroxyl value ratio=2/98, water tolerance: infinite, product of Sanyo Chemical Industries) and 10 parts of U-Van 28-70 W (butylated melamine, product of Mitsui Chemical) and the mixture was stirred at 80° C. for 1 hour. The thus-obtained melamine-cocondensation product polyether polyol was used.

Curing agent D-1

Cymel 204 (mixed alkylated melamine resin, water tolerance: 3.6 ml, product of Mitsui Cytec) was used.

Curing agent D-2

A reaction vessel equipped with a stirrer, a nitrogen inlet tube, a condenser and a thermometer was charged with 840 parts of hexamethylene diisocyanate and, after dilution with 609 parts of methyl isobutyl ketone, 0.9 part of dibutyltin laurate was added and, after raising the temperature to 50° C., 223.5 parts of trimethylolpropane was added gradually so that the resin temperature might not exceed 60° C. Then, 435 parts of methyl ethyl ketone oxime was added so that the resin temperature might not exceed 70° C. The mixture was maintained at 70° C. for 1 hour until the isocyanato group-due absorption in infrared absorption spectrum has substantially disappeared. Thereafter, the mixture was diluted with 32 parts of n-butanol. A blocked isocyanate was thus synthesized. The blocked isocyanate obtained had a solid content of 70%.

Production of a polyester resin G-1

A reaction vessel was charged with 22.3 parts of isophthalic acid, 19.9 parts of phthalic anhydride, 15.4 parts of adipic acid, 0.1 parts of trimethylol propane, 37.1 parts of neopentyl glycol, 5.2 parts of dimethylol propionic acid, 0.1 parts of dibutyltin oxide. The mixture was heated to 170° C. with stirring, and then heated to 220° C. over 3 hours while removing byproduct water due to condensation reaction. The reaction mixture was cooled when it has the solid acid value of 25. After cooling to 80° C., 3.2 parts of dimethylethanolamine, 204.4 parts of deionized water were added thereto. The polyester resin G-1 obtained had a nonvolatile matter content of 30%, a solid acid value of 25, a hydroxy value of 28 and a number average molecular weight of 4000.

Production of an alkyd resin G-2

A reaction vessel was charged with 18.1 parts of isophthalic acid, 16.1 parts of phthalic anhydride, 12.5 parts of adipic acid, 7.7 parts of trimethylol propane, 20.7 parts of neopentyl glycol, 5.7 parts of dimethylolpropionic acid, 19.2 parts of coconut oil, dibutyltin oxide. The mixture was heated to 170° C. with stirring, and then heated to 220° C. over 3 hours while removing byproduct water due to condensation reaction, followed by removing water by a zeotropic distillation with xylene of 2% of solid matter weight. The reaction mixture was cooled when it has the solid acid value of 25. After cooling to 80° C., 3.3 parts of dimethylethanolamine, 206.9 parts of deionized water were added thereto. The alkyd resin G-2 obtained had a nonvolatile matter content of 30%, a solid acid value of 25, a hydroxy value of 28 and a number average molecular weight of 4000.

### Example 1

Production of a water-based metallic coating composition

Alpaste MH 8801 (aluminum pigment paste, product of Asahi Chemical Industry; 21 parts) was dissolved in 20 parts of 2-ethylhexyl glycol and, then, 10 parts of Primepol PX-1000 (bifunctional polyether polyol, number average molecular weight 400, hydroxyl value 278, primary/secondary hydroxyl value ratio=63/37, water tolerance infinite, product of Sanyo Chemical Industries) was added gradually with stirring by means of a table dispersion mixer (Disper) to give an aluminum pigment-containing metallic pigment paste. The aluminum pigment-containing metallic pigment paste obtained was a uniform metallic pigment paste without allowing the aluminum pigment to sediment.

Then, the above aluminum pigment-containing metallic pigment paste was admixed with 275 parts of resin emulsion A-1, 33 parts of acrylic resin B-1, 25 parts of Cymel 204 (methylated melamine resin, product of Mitsui Chemical) as curing agent D-1, 10 parts of a 10% aqueous solution of dimethylethanolamine and 0.3 part of lauryl acid phosphate and the mixture was stirred to effect uniform dispersion, whereby a water-based metallic coating composition was obtained.

Multilayer coating formation

Zinc phosphate-treated dull steel plates, 0.8 mm thick, 30 cm long and 40 cm wide, which had been coated with a cationic electrodeposition coating (“Powertop U-50”, product of Nippon Paint) in a dry film thickness of 20 μm by electrodeposition, followed by 30 minutes of baking at 160° C., were coated with a gray intermediate coat coating (“Orga P-2”, polyester-melamine base coating, product of Nippon Paint) diluted beforehand to a viscosity of 25 seconds (as determined at 20° C. using a No. 4 Ford cup) so as to attain a dry film thickness of 35 μm in two stages using an air spray gun, and baking was effected at 140° C. for 30 minutes.

After cooling, the above water-based metallic coating composition was diluted with deionized water to a viscosity of 30 seconds (measured at 20° C. using a No. 4 Ford cup) and applied in two stages so as to attain a dry film thickness of 20 μm at room temperature (25° C.) and a humidity of 85% using a model “μ μ Bell COPES-IV” coater for water-based coatings (product of ABB Industries). One minute of interval setting was effected between the two coating operations. After the second coating operation, setting was effected for an interval of 5 minutes. Then, preheating was performed at 80° C. for 5 minutes.

After preheating, the coated panels were allowed to cool to room temperature, “Orga TO-563 Clear” (acrylic-melamine base clear coating, product of Nippon Paint) was applied, as a clear coating, thereto in one stage so as to attain a dry film thickness of 40 μm, followed by 7 minutes of setting. The coated panels were then baked at 140° C. for 30 minutes using a drier.

The coated panels were evaluated for whiteness of coating film by measuring the L value using a CR-300 color difference meter (product of Minolta).

Separately, the coated panels obtained were immersed in warm water (40° C.) for 10 days, then washed and, an hour later, observed by the eye for appearance evaluation according to the following criteria:

### <Criteria for warm water resistance evaluation>

5: No change;

4: Slight swelling on the interface of warm water;

3: Slight darkening on the interface of warm water;

2: Blackening on the interface of warm water;

1: Swelling on the interface of warm water and blackening of the coating film.

The results obtained in the above manner are shown in Table 1.

### Examples 2 and 3

Aluminum pigment pastes and water base metallic base coating compositions were prepared in the same manner as in Example 1 by compounding the components specified in Table 1. Further, multilayer coating films were formed and evaluated in the same manner as in Example 1. In Example 2, the curing agent D-1 and the curing agent D-2 were used in amounts of 12.5 parts and 12.5 parts, respectively.

### Examples 4 to 6

Water-based metallic coating compositions were prepared by adding 5 parts of the phosphoric acid group-containing acrylic resin in the production example mentioned above to the metallic pigment pastes specified in Table 1 and incorporating the other components in the same manner as in Example 1. Further, multilayer coating films were formed and evaluated in the same manner as in Example 1. In Example 5, the curing agent D-1 and the curing agent D-2 were used in amounts of 12.5 parts and 12.5 parts, respectively.

### Example 7

The resin emulsion A-1 (137.5 parts) obtained in the above production example, 5 parts of a 10% (by weight) aqueous solution of dimethylethanolamine, 33 parts of the acrylic resin B-1, 91.7 parts of the polyester resin G-1, 10 parts of the polyether polyol C-1-1, 25 parts of the curing agent D-1, 21 parts of Alpaste MH 8801 (aluminum pigment, product of Asahi Chemical Industry) (as luster pigment E-1), 5 parts of the phosphoric acid group-containing acrylic resin and 0.3 part of lauryl acid phosphate were blended and, after attaining uniform dispersion, a water-based metallic base coat coating was obtained. Multilayer coating films were formed using the metallic base coatings obtained and were evaluated in the same manner as in Example 1.

### Example 8

A water-based metallic base coating was prepared in the same manner as in Example 7 by compounding the same components except that 91.7 parts of the alkyd resin G-2 obtained in the above method were used in lieu of polyester resin G-1. Using the metallic base coating obtained, multilayer coating films were formed and evaluated in the same manner as in Example 1.

### Comparative Example 1

A water base metallic base coating composition was prepared in the same manner as in Example 1 by compounding the same components except that the use of the polyester polyol was omitted, and multilayer coating films were formed and evaluated in the same manner.

The evaluation results obtained in the above examples and comparative example are summarized in Table 1.

TABLE 1

| | | | | | | | | | Compar. |
|---|---|---|---|---|---|---|---|---|---|
| | Example | | | | | | | | Ex. |
| | 1 | 2 | 3 | 4 | 5 | 6 | 7 | 8 | 1 |
| Coating Composition | | | | | | | | | |
| Luster pigment | E-1 | E-1 | E-1 | E-1 | E-1 | E-1 | E-1 | E-1 | A-3 |
| Solvent | F-1 | F-1 | F-1 | F-1 | F-1 | F-1 | F-1 | F-1 | B-1 |
| Polyether polyol | C-1 | C-2 | C-3 | C-1 | C-2 | C-3 | C-1 | C-1 | No |
| Curing agent | D-1 | D-1/ | D-1 | D-1 | D-1/ | D-1 | D-1 | D-1 | D-1 |
| | | D-2 | | | D-2 | | | | |
| Other film-forming | B-1 | B-1 | B-1 | B-1 | B-1 | B-1 | B-1/ | B-1/ | E-1 |
| resin | | | | | | | G-1 | G-2 | |
| Resin emulsion | A-1 | A-1 | A-1 | A-1 | A-1 | A-1 | A-1 | A-1 | A-1 |
| Phosphoric acid group- | No | No | No | Yes | Yes | Yes | No | No | No |
| containing acrylic resin | | | | | | | | | |
| Evaluation | | | | | | | | | |
| Coating film L value | 86 | 87 | 87 | 82 | 83 | 83 | 88 | 89 | 2 |
| Water resistance | 4 | 4 | 4 | 5 | 5 | 5 | 4 | 4 | 2 |

As the examples of the invention indicate, imbibing or inversion on the coating film interface can be controlled and thus multilayer coating films having a high L value and good luster can be obtained owing to the interaction between the polyether polyol and resin emulsion contained in the water-based metallic base coatings.

1. A water-based metallic coating composition
which comprises a metallic pigment paste comprising a dispersion prepared in advance from a polyetherpolyol, a luster pigment and an organic solvent,
said polyether polyol having at least 0.02 primary hydroxyl group, on average, per molecule and a water tolerance of not less than 2.0.

2. The water-based metallic coating composition according to claim 1
which comprises a resin emulsion obtained by emulsion polymerization.

3. The water-based metallic coating composition according to claim 1 or 2,
wherein said polyether polyol has at least one primary hydroxyl group in each molecule and has a hydroxyl value of 30 to 700.

4. The water-based metallic coating composition according to any of claims 1 to 3,
wherein said polyether polyol has at least three primary hydroxyl groups in each molecule.

5. The water-based metallic coating composition according-to any of claims 1 to 4
which comprises a polyester resin or an alkyd resin.
